(19) United States
(12) Patent Application Publication
(10) Pub. No.: US 2011/0050729 A1
(43) Pub. Date: Mar. 3, 2011

(54) SYSTEM AND METHOD FOR ADJUSTING DISPLAY ORIENTATION

(75) Inventors: Li Li, Shanghai (CN); Liang Huang, Shanghai (CN); Shih-Kuang Tsai, Shanghai (CN)

(73) Assignees: INVENTEC APPLIANCES (SHANGHAI) CO., LTD.; INVENTEC APPLIANCES CORP.

(21) Appl. No.: 12/794,249

(22) Filed: Jun. 4, 2010

(30) Foreign Application Priority Data
Aug. 28, 2009 (CN) 200910194775.6

(51) Int. Cl. G09G 5/00; G06K 9/00

(52) U.S. Cl. 345/649; 382/103

(57) ABSTRACT

A display adjustment system (20) rotates the display to in response to a change of the eyelevel line of the viewer. The display adjustment system (20) includes an imaging module (11), an eyelevel tracking module (22), and a display rotation module (24). The imaging module (11) captures an image of the viewer with the pupils. The eyelevel tracking module (22) calculates the direction of an eyelevel line connecting the two pupils. The display adjustment module (24) rotates the display in response to a change in the direction of the eyelevel line, so that the display remains substantially parallel to the direction of the eyelevel line. The eyelevel tracking module (22) and the display adjustment module (24) can be implemented via software, firmware, hardware, or any combination thereof.

### FIELD OF THE INVENTION

The present invention generally relates to video display and, more particularly, to adjusting video display orientation for viewing comfort or convenience.

### BACKGROUND OF THE INVENTION

As digital media gain popularity, people spend more and more time surfing internet, watching digital media programs, reading articles, playing video games, etc., on personal computers, digital media devices, or other electronic devices with video displays. It is generally more comfortable to view a display when the display panel is parallel to the face of the viewer and an reference line corresponding to horizontal is parallel to a line connecting two pupils of the viewer. When viewing a display, two pupils of a viewer in generally on the same level, i.e., the line connecting the two pupils are generally horizontal. To accommodate this normal and most common posture of the viewer, the display panel of a personal computer placed on a leveled desk surface generally has its top and bottom sides substantially horizontal. The display of a document is generally in an upright orientation so that the lines of the text in the document is parallel to the top side of the display panel.

A viewer sometimes departs from the normal posture when using a personal computer. For example, the viewer may tilt his head to a side in order to reach an object or take a more comfortable or restful posture. When the viewer tilts his head, he would view the display panel at an angle. There are computers on the market that enable the viewer to use keys or a user interface to rotate the document on display to an orientation parallel to the viewer's eyelevel. Rotating the document requires the viewer to consciously adjust the document on display, which is inconvenient because the viewer may often tilt his head in a subconscious move and stay in the tilted posture for an indefinite time before readjusting this head to another position. Furthermore, it would be difficult to rotate the document precisely. The viewer may rotate the document on display too much or too little for his viewing comfort.

Accordingly, it would be advantageous to have an electronic device with video display and a method for adjusting the display for viewing comfort. It is desirable for the method to be able to adjust the display automatically following viewer's movement. It is also desirable to be able to adjust the display with high precision. It would be of further advantage if the video display adjustment can be implemented easily and cost efficiently.

### BRIEF DESCRIPTION OF THE DRAWINGS

FIG. 1 is a functional block diagram illustrating an electronic device having a video display adjustment mechanism implemented thereon in accordance with an embodiment of the present invention;

FIG. 2 is a functional block diagram illustrating a display adjustment system in accordance with an embodiment of the present invention;

FIG. 3 is a schematic diagram illustrating a display panel having an eyelevel detection unit in accordance with an embodiment of the present invention; and

FIG. 4 is a flowchart illustrating a display adjustment process in accordance with an embodiment of the present invention.

### DETAILED DESCRIPTION OF VARIOUS EMBODIMENTS

Various embodiments of the present invention are described herein below with reference to the figures, in which elements of similar structures or functions are represented by like reference numerals throughout the figures. It should be noted that the figures are only intended to facilitate the description of various embodiments of the present invention. They are not intended as an exhaustive description of the present invention or as a limitation on the scope of the present invention. Furthermore, the figures are not necessarily drawn to scales.

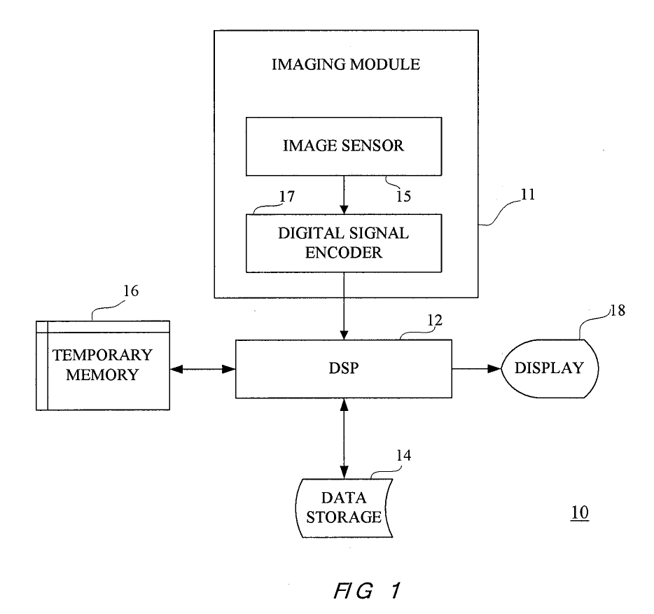

FIG. 1 is a functional block diagram illustrating an electronic device 10 having a video display mechanism implemented thereon in accordance with an embodiment of the present invention. It should be noted that FIG. 1 shows only those elements in device 10 necessary for the description of the structure and operation of device 10 in accordance with a preferred embodiment of the present invention. By way of example, electronic device 10 may be a desktop personal computer, a laptop personal computer, a personal digital assistant (PDA), a mobile telephone, a digital media device, etc.

Device 10 includes a digital signal processing unit (DSP) 12, a data storage unit 14, a memory unit 16, and a display element or unit 18. Data storage unit 14, memory unit 16, and display unit 18 are coupled to DSP 12 via signal transmission buses. In accordance with the present invention, DSP 12 may include a microprocessor (μP), a microcontroller (μC), a central processing unit (CPU), or the likes. Data storage unit 14 may include one or more nonvolatile memory units such as, for example, a magnetic hard disc, an optical memory disk, read only memory (ROM), flash memory, ferroelectric random access memory (FeRAM), magentoresistive random access memory (MRAM), etc. Memory unit 16 may include a cache memory unit or a volatile memory unit such as, for example, dynamic random access memory (DRAM), static random access memory (SRAM), zero capacitor random access memory (Z-RAM) twin-transistor random access memory (TTRAM), etc. Display unit 18 may include a video display of various kinds, such as, for example, liquid crystal display (LCD), cathode ray tube display (CRT), electroluminescent display (ELD), light emitting diode display (LED), etc. In accordance with the present invention, device 10 may include additional elements not shown in FIG. 1. For example, device 10 may also include a data input system, a user interface, an audio system, a radio, a global positioning system (GPS), etc.

Electronic device 10 also includes an imaging module 11. In accordance with a preferred embodiment, imaging module 11 includes an image sensor 15 and a signal encoder 17 coupled thereto. Image sensor 15 includes an array of photoelectric light sensors, e.g., charge-coupled device (CCD) sensors, complementary metal-oxide-semiconductor (CMOS) sensors, etc., for generating electric signals in response to light images. Digital signal encoder 17 is also coupled to DSP 12. Digital signal encoder 17 encodes the electric signal from image sensor 15 into data packets and, transmits the data packets to DSP 12.

In operation, DSP 12 processes user commands and data inputs and generates operation codes to data storage unit 14, memory unit 16, and display unit 18. For example, when a user wants to view a file, the user may use a keyboard or keypad (not shown in FIG. 1) to input the filename or click on a file icon. In response to the user input, DSP 12 searches data storage unit 14 for the corresponding file. After locating the file, DSP 12 stores at least a portion of the file in memory unit 16. In response to user instructions, DSP 12 selects sections of data in memory unit 16 and displays the data on display unit 18.

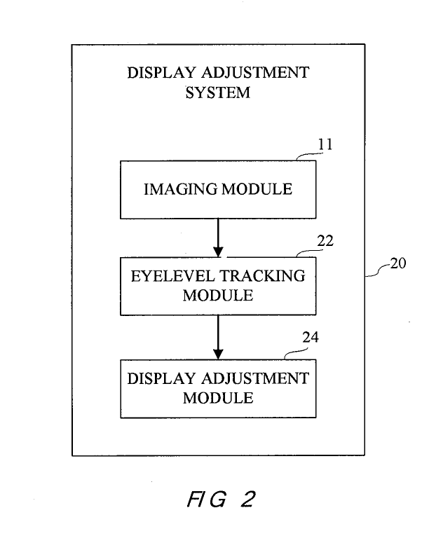

FIG. 2 is a functional block diagram illustrating a display adjustment system 20 in accordance with an embodiment of the present invention. By way of example, display adjustment system 20 is implemented on electronic device 10 described herein above with reference to FIG. 1. In addition to imaging module 11, display adjustment system 20 includes an eyelevel tracking module 22 and a display adjustment or rotation module 24. In accordance with an embodiment of the present invention, eyelevel tracking module 22 and display rotation module 24 are implemented in one or more integrated circuit chips. In this embodiment, imaging module 11 is coupled to DSP 12 (shown in FIG. 1) through eyelevel tracking module 22 and display adjustment module 24. In accordance with an alternative embodiment, eyelevel tracking module 22 and display rotation module 24 are implemented through firmware in a ROM. In accordance with another alternative embodiment, eyelevel tracking module 22 and display rotation module 24 are implemented through software stored in data storage unit 14 shown in FIG. 1.

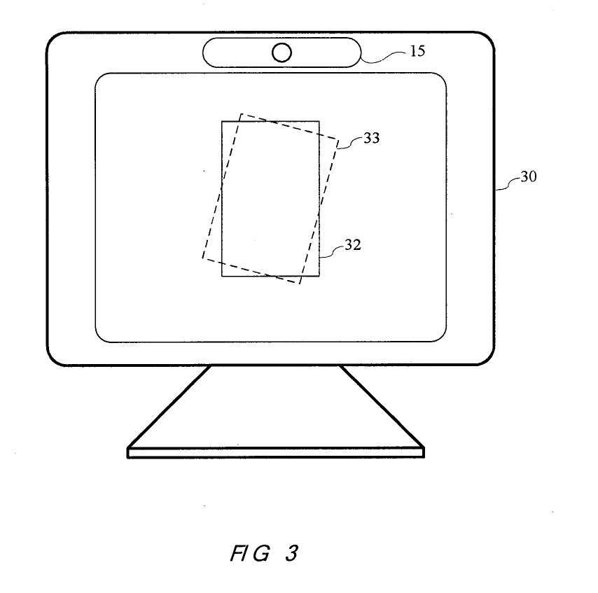

FIG. 3 is a schematic diagram illustrating a front view of a display panel 30 in accordance with an embodiment of the present invention. By way of example, display panel 30 is an LCD panel in display unit 18 of electronic device 10 shown in FIG. 1. In accordance with an embodiment of the present invention, image sensor 15 in imaging module 11 is installed on display panel 30. FIG. 3 shows image sensor 15 being installed in the middle of the topside of display panel 30. However, this is not intended as a limitation on the scope of the present invention. In accordance to the present invention, image sensor 15 may be disposed on the bottom, on the side, or at a corner of display panel 30. Furthermore, image sensor 15 is not limited to being installed on display panel 30. Image sensor may be disposed separately from display panel 30. For example, image sensor 15 may be placed on a desk and coupled to device 10 through either a wired connection, e.g., a universal serial bus (USB), or a wireless connection, e.g., a wireless connection following the Bluetooth protocol.

In a normal mode, a file 32 is displayed in an upright orientation on display panel 30, so that the a reference line, e.g., a line of text, in file 32, is substantially parallel to the upside of display panel 30. When activated, image sensor 15 in imaging module 11 captures an image of the face of the viewer. Signal encoder 17 encodes the image signals generated by image sensor 15 and transmits the encoded digital signal to eyelevel tracking module 22. Eyelevel tracking module 22 processes the encoded digital signal to identify the pupils of the viewer and calculates the direction of a line connecting the pupils, which may be referred to as an eyelevel line. In accordance with a preferred embodiment of the present invention, eyelevel tracking module 22 calculates an angle between the eyelevel line with the horizontal direction and generates a digital tracking signal indicating the direction of the eyelevel line. When the viewer tilts his head, the eyelevel line would be inclined at an angle with the horizontal direction. Display adjustment module 24 processes the digital tracking signal from eyelevel tracking module 22 and adjust the orientation of file 32 accordingly. For example, in response to the viewer tilting his head to right and eyelevel tracking module 22 detecting an angle of five degrees (5°) between the eyelevel line and the horizontal, display adjustment module 24 generates a command to rotate the display of file 32 to the right for an angle of 5° as indicated by element 33 in FIG. 3.

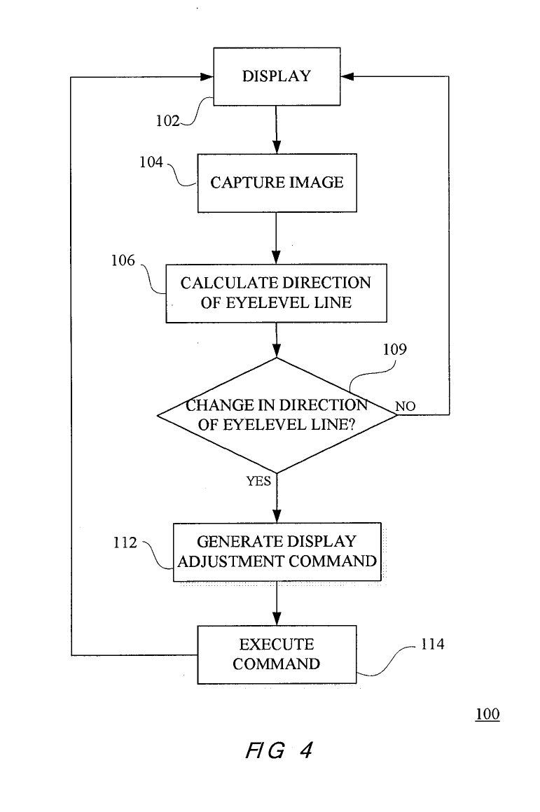

FIG. 4 is a flowchart illustrating a display adjustment process 100 in accordance with an embodiment of the present invention. By way of example, display adjustment process 100 may be implemented in electronic device 10 shown in FIG. 1. However, this is not intended as a limitation on the scope of the present invention. In accordance with the present invention, process 100 may be implemented in other devices having a display adjustment or rotating system, e.g., display adjustment system 20 as shown in FIG. 2. In accordance with a preferred embodiment of the present invention, process 100 tracks the eyelevel of the viewer and adjusts the orientation of the display so that a reference line of the display remains substantially parallel to the eyelevel of the viewer.

Display adjustment process 100 starts with displaying a document or a file on a display panel, e.g., display panel 30 in electronic device 10 described supra with reference to FIGS. 1 and 3, in a step 102. Initially, a reference line in the display, e.g., a line of text in a text file, is substantially parallel to a reference line, e.g., the topside, of the display panel.

In a step 104, process 100 captures an image of the face of the viewer including the eyes. In accordance with a preferred embodiment of the present invention, step 104 captures the image through an array of photoelectric light sensors. The photoelectric sensor array generates electric signals in response to light images. A signal encoder encodes the electric signals from the sensor array into data packets describing the image. In accordance with an embodiment of the present invention, step 104 repeatedly captures the image of the viewer's face at a predetermined rate, e.g., a rate ranging between every 50 milliseconds and every 2 seconds. In accordance with a preferred embodiment, the rate of image capturing rate is adjustable.

In a step 106, process 100 processes the data packets to calculate the direction of an eyelevel line that connects the pupils of the viewer. In accordance with a preferred embodiment, step 106 processes the data packets to track the eyelevel line in an integrated circuit chip. In accordance with another preferred embodiment, step 106 tracks the eyelevel line via a software program implemented in a digital signal processing unit, e.g., DSP 12 in electronic device 10 shown in FIG. 1. In accordance with yet another preferred embodiment, step 106 tracks the eyelevel line via an embedded firmware. In accordance with one embodiment of the present invention, step 106 calculates an angle between the eyelevel line and the horizontal direction. In accordance with another embodiment of the present invention, step 106 tracks the change in the direction of the eyelevel line.

In a step 109, process 100 checks whether there is any change in the direction of eyelevel line. In response there is no significant change, process 100 returns to step 104 for capturing the next image of the viewer's face. In response there is a change in the direction of the eyelevel line beyond a predetermined threshold, process 100 proceeds to a subsequent step 112. In accordance with the present invention, the threshold can take any value, e.g., 1°, 2°, 3°, 4°, 5°, and so on. In accordance with a preferred embodiment, the threshold can be set to different values to accommodate different viewing habits or preferences of the viewers. In accordance with a preferred embodiment, step 109 is implemented in an integrated circuit in an eyelevel tracking module. In accordance with another preferred embodiment, step 109 is implemented via a software program implemented in a digital signal processing unit, e.g., DSP 12 in electronic device 10 shown in FIG. 1. In accordance with yet another preferred embodiment, step 109 is implemented via an embedded firmware.

In accordance with one embodiment of the present invention, process 100 proceeds to step 109 every time step 104 calculates a direction of the eyelevel line. In this embodiment, process 100 performs step 106 and subsequent step 109 at the same rate as step 104 capturing the image of the viewer. In accordance with another embodiment, process 100 repeatedly performs step 104 and 106 for a plurality of times, e.g., five time, ten times, etc., before proceeding to step 109. In this embodiment, step 109 checks whether there is a change in an average direction of the eyelevel line calculated from multiple images captured in step 104 and calculated in step 106. In accordance with a preferred embodiment, process 100 calculates a weighed average direction of the eyelevel line with a weighing factor favoring later images over earlier images.

In step 112, process 100 calculates the extend of the display adjustment in response to the change in the direction of the eyelevel line. In accordance with one embodiment, step 112 generates a command to rotate the display in the same direction and for an angle substantially equal to the change in the direction of the eyelevel line. In accordance with another embodiment, step 112 rotates the display in the same direction as the rotation of the eyelevel line and for an angle corresponding to a range of angles for the rotation of the eyelevel line. For example, in response to the eyelevel line rotating clockwise for an angle in a range between 1° and 5°, step 112 generates a command to rotate the display clockwise for an angle of 2°. Also by way of example, in response to the eyelevel line rotating counterclockwise for an angle between 6° and 10°, step 112 generates a command to rotate the display counterclockwise for an angle of 8°. In accordance with yet another embodiment, step 112 generates a command to rotate the display so that a reference line in the display remains substantially parallel to the eyelevel line. In accordance with the present invention, step 112 can be implemented through hardware, software, or firmware approaches.

In a subsequent step 114, process 100 executes the command generated in step 112 to adjust or rotate the display on the display panel, e.g., display panel 30 shown in FIG. 3. Then process 100 returns to step 114 to capture the next image of the viewer.

It should be understood that display adjustment process 100 is not limited to being the same as described herein above. For example, process 100 includes a delay mechanism that adjusts the display only after the eyelevel line changes in direction for a time interval longer than a predetermined value, e.g., three seconds, in accordance with an alternative embodiment of the present invention. In this embodiment, sudden and short movement of viewer will be filtered out and not cause the display to rotate, thereby substantially eliminating the jittering of the display.

By now it should be appreciated that a device having a display and a method for adjusting the display to accommodate viewer's motion have been provided. In accordance with the present invention, an electronic device includes a display adjustment mechanism that rotates the display in response to the change of the eyelevel line of the viewer. Therefore, the viewer would be able to view display in a natural orientation regardless of the viewer's posture. In accordance with the present invention, the display adjustment mechanism includes an imaging module, an eyelevel tracking module, and a display rotation module. The imaging module includes a photoelectric sensor to capture an image of the viewer with the pupils. The eyelevel tracking module calculates a direction of the eyelevel line connecting the pupils. The display rotation module rotates the display in response to the change in the direction of the eyelevel line. The eyelevel tracking module and the display rotation module can be implemented via software, hardware, of firmware. Therefore, it is cost efficient to implement the display adjustment system in various kinds of devices such as, for example, desktop computers, laptop computers, personal digital assistants, mobile telephones, digital media devices, etc. A display adjustment process in accordance with the present invention adjusts the display to accommodate the movement of the viewer, thereby potentially reducing the fatigue and enhancing the viewing experience. In accordance with the present invention, the adjustment of the display in response to viewer's movement is automatic without viewer's intervention. Furthermore, the sensitivity, response time, and extent of the display rotation can be tuned to produce stable display for pleasant viewing.

While specific embodiments of the present invention have been described herein above, they are not intended as limitations on the scope of the invention. The present invention encompasses those modifications and variations of the described embodiments that are obvious to those skilled in the art. For example, a display adjustment mechanism in accordance with the present invention is not limited being implemented within an electronic device, e.g., a personal computer. The display adjustment mechanism can be implemented in a stand alone apparatus and connected with the electronic device with a wired or wireless connection.

1. An electronic device (10), comprising:
a display panel (30);
an imaging module (11) disposed adjacent said display panel (30) and configured to capture an image of two pupils of a viewer viewing said display panel (30);
an eyelevel tracking module (22) coupled to said imaging module (11) and configured to calculate a direction of an eyelevel line connecting the two pupils of the viewer and generate a digital tracking signal; and
a display adjustment module (24) receiving the digital tracking signal from said eyelevel tracking module (22) and configured to generate a command for adjusting a display on said display panel (30) in response thereto.

2. The electronic device (10) of claim 1, wherein said imaging module (11) includes an array of photoelectric sensors.

3. The electronic device (10) of claim 1, wherein said eyelevel tracking module (22) and said display adjustment module (24) are implemented on an integrated circuit chip.

4. The electronic device (10) of claim 1, further comprising a digital signal processing unit (12), wherein said eyelevel tracking module (22) and said display adjustment module (24) are implemented in said digital signal processing unit (12).

5. The electronic device (10) of claim 1, wherein said display adjustment module (24) is configured to generate the command for adjusting the display on said display panel (30) to be substantially parallel to the eyelevel line.

6. A display adjustment system (20) for adjusting a display orientation on a display panel in response to a viewer movement, comprising:
an imaging module (11) configured to capture an image of two pupils of the viewer viewing the display panel;
an eyelevel tracking module (22) coupled to said imaging module (11) and configured to generate a tracking signal corresponding to a direction of an eyelevel line connecting the two pupils of the viewer; and
a display adjustment module (24) configured to generate a command for adjusting the display in response to the tracking signal from said eyelevel tracking module (22).

7. The display adjustment system (20) of claim 6, wherein said eyelevel tracking module (22) is implemented via a software program.

8. The display adjustment system (20) of claim 6, wherein said display adjustment module (24) is implemented via a software program.

9. The display adjustment system (20) of claim 6, wherein said imaging module (11) is configured to capture the image at a predetermined rate.

10. The display adjustment system (20) of claim 6, wherein said display adjustment module (24) is configured to generate the command for rotating the display in response to the said eyelevel tracking module (22) sensing a change in the direction of the eyelevel line.

11. A method for adjusting a display orientation, comprising:
capturing an image of two pupils of a viewer viewing the display;
calculating a direction of an eyelevel line connecting the two pupils; and
adjusting an orientation of the display in response to the direction of the eyelevel line.

12. The method as claimed in claim 11, wherein capturing an image of two pupils of a viewer includes repeatedly capturing a plurality of images of the two pupils at a predetermined rate.

13. The method as claimed in claim 12, wherein calculating a direction of an eyelevel line includes calculating an average direction of the eyelevel line in response to the plurality of images of the two pupils.

14. The method as claimed in claim 11, wherein adjusting an orientation of the display includes rotating the display in response to a change in the direction of the eyelevel line exceeding a threshold value.

15. The method as claimed in claim 11, wherein adjusting an orientation of the display includes adjusting the orientation of the display to be substantially parallel to the direction of the eyelevel line.

16. The method as claimed in claim 11, wherein adjusting an orientation of the display includes rotating the display over an angle in response to a change in the direction of the eyelevel line within a range.

17. The method as claimed in claim 11, wherein adjusting an orientation of the display includes rotating the display in response to a change in the direction of the eyelevel line for a time longer than a predetermined time interval.

18. The method as claimed in claim 11, wherein capturing an image of two pupils includes generating a digital signal describing the image.

19. The method as claimed in claim 18, wherein calculating a direction of an eyelevel line connecting the two pupils includes processing the digital signal in a digital signal processing unit.

20. The method as claimed in claim 18, wherein calculating a direction of an eyelevel line connecting the two pupils includes calculating the direction via a software program implemented in a microprocessor.
